(19) United States
(12) Patent Application Publication
(10) Pub. No.: US 2025/0052971 A1
(43) Pub. Date: Feb. 13, 2025

(54) CABLE HOLDER STRUCTURALLY CONFIGURED TO SEALING HOLD DIFFERENT SIZED CABLES

(71) Applicant: PPC BROADBAND, INC., East Syracuse, NY (US)

(72) Inventors: Kim LEESON, Ipswich (GB); Shaun TREZISE, Aldeburgh (GB)

(73) Assignee: PPC BROADBAND, INC., East Syracuse, NY (US)

(21) Appl. No.: 18/798,808

(22) Filed: Aug. 8, 2024

Related U.S. Application Data
(60) Provisional application No. 63/531,474, filed on Aug. 8, 2023.

(51) Int. Cl. G02B 6/44

(52) U.S. Cl. CPC G02B 6/4444; G02B 6/4445

(57) ABSTRACT

A cable holder may include a body portion, a cable receiving portion structurally configured to extend through the body portion along a longitudinal axis of the body portion, and a sealing portion structurally configured to be coupled with the body portion. The sealing portion may include an engagement portion structurally configured to extend radially inward from the body portion into the cable receiving portion so as to narrow a cross-sectional passage through the cable receiving portion. A first portion of the engagement portion may be structurally configured to sealingly engage a cable having a first outside diameter that is greater than or equal to a first diameter and less than a second diameter, and the first portion and the second portion may be structurally configured to sealingly engage a cable having a second outside diameter that is greater than or equal to the second diameter such that the cable holder is structurally configured to sealingly hold cables having different sized diameters.

### CROSS-REFERENCE TO RELATED APPLICATION

This application claims the benefit of U.S. Provisional Patent Application No. 63/531,474, filed on Aug. 8, 2023, the disclosure of which is hereby incorporated by reference herein in its entirety.

### TECHNICAL FIELD

The present disclosure is directed to a cable seal and, more particularly, to an assembly to seal a push-fit cartridge system.

### BACKGROUND

As computers and semiconductors have become more universally utilized, the amount of data being generated, transferred, and stored has drastically increased. While source and end devices to create and store data have advanced to meet the data needs of users, data transmission infrastructure has challenges that can inhibit peak data transfer reliability and/or performance.

In fiber cabling that can provide data transmission capabilities, interconnections can be employed to provide distribution and connectivity to multiple different sites. Such interconnections can pose difficulties and inefficiencies during installation and thereafter. For instance, an connection, coupling, or splice can inadvertently take a long time to correctly install and endure mechanical and environmental stresses after installation that jeopardize the integrity and reliability of the interconnection as well as data transmission.

For these reasons, it is a continued goal for cable interconnections configured to provide more robust resistance to mechanical and environmental stresses along with reduced susceptibility to installation delays and errors.

### SUMMARY

In accordance with various aspects of the disclosure, a cable holder may include a body portion, a cable receiving portion structurally configured to extend through the body portion along a longitudinal axis of the body portion, a sealing portion structurally configured to be coupled with the body portion, and a retaining portion structurally configured to be coupled with the body portion. The retaining portion may be structurally configured to engage a cable that extends through the cable receiving portion so as to prevent relative movement between the cable and the body portion along the longitudinal axis. The body portion may include a first body portion hingedly coupled with a second body portion, and the body portion may comprise a single piece of unitary construction such that the first body portion and the second body portion are hingedly coupled via a living hinge. The sealing portion may include a first sealing portion configured to be received by the first body portion and a second sealing portion configured to be received by the second body portion, and the scaling portion may include an engagement portion structurally configured to extend radially inward from the body portion into the cable receiving portion so as to narrow a cross-sectional passage through the cable receiving portion. The engagement portion may include a first engagement portion and a second engagement portion spaced apart from one another along the longitudinal axis, the first engagement portion may extend further into the cable receiving portion than the second engagement portion such that the first engagement portion defines a first opening through the cable receiving portion that is smaller than a second opening defined by the second engagement portion, and the first engagement portion and the second engagement portion may be configured to be biased radially outward toward the body portion. The first engagement portion may be structurally configured to sealingly engage a cable having a first outside diameter that is greater than or equal to a diameter of the first opening and less than a diameter of the second opening, and the first engagement portion and the second engagement portion are structurally configured to sealingly engage a cable having a second outside diameter that is greater than or equal to the diameter of the second opening such that the cable holder is structurally configured to sealingly hold cables having different sized diameters

According to various aspects of the disclosure, a cable holder may include a body portion, a cable receiving portion structurally configured to extend through the body portion along a longitudinal axis of the body portion, and a sealing portion structurally configured to be coupled with the body portion. The body portion may include a first body portion hingedly coupled with a second body portion, and the scaling portion may include an engagement portion structurally configured to extend radially inward from the body portion into the cable receiving portion so as to narrow a cross-sectional passage through the cable receiving portion. A first portion of the engagement portion may extend further into the cable receiving portion than a second portion of the engagement portion such that the first portion defines a first opening through the cable receiving portion that is smaller than a second opening defined by the second portion. The first portion may be structurally configured to sealingly engage a cable having a first outside diameter that is greater than or equal to a diameter of the first opening and less than a diameter of the second opening, and the first portion and the second portion may be structurally configured to sealingly engage a cable having a second outside diameter that is greater than or equal to the diameter of the second opening such that the cable holder is structurally configured to sealingly hold cables having different sized diameters

In accordance with various aspects of the disclosure, cable holder may include a body portion, a cable receiving portion structurally configured to extend through the body portion along a longitudinal axis of the body portion, and a sealing portion structurally configured to be coupled with the body portion. The sealing portion may include an engagement portion structurally configured to extend radially inward from the body portion into the cable receiving portion so as to narrow a cross-sectional passage through the cable receiving portion. A first portion of the engagement portion may be structurally configured to sealingly engage a cable having a first outside diameter that is greater than or equal to a first diameter and less than a second diameter, and the first portion and the second portion may be structurally configured to sealingly engage a cable having a second outside diameter that is greater than or equal to the second diameter such that the cable holder is structurally configured to sealingly hold cables having different sized diameters.

### BRIEF DESCRIPTION OF THE DRAWINGS

Further advantages and features of the present disclosure will become apparent from the following description and the accompanying drawings, to which reference is made.

FIG. 1 is a line representation of portions of a cable assembly in which assorted embodiments can be practiced.

FIG. 2 is a line representation of portions of an example cable assembly that can be employed in the environment of FIG. 1 in various embodiments.

FIGS. 3A and 3B respectively convey perspective views of portions of an example cable seal that can be employed in the assemblies of FIGS. 1 and 2.

FIGS. 4A and 4B respectively convey perspective views of portions of an example cartridge system employed in accordance with various embodiments.

FIGS. 5A and 5B respectively convey assorted views of portions of an example cartridge system arranged in accordance with various embodiments.

FIG. 6 is a perspective view of portions of an example cartridge system configured in accordance with various embodiments.

### DETAILED DESCRIPTION

Reference will now be made in detail to presently preferred embodiments and methods of the present disclosure, which constitute the best modes of practicing the present disclosure presently known to the inventors. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

The interconnection of a signal carrying cable, particularly fiber optic cables, can be susceptible to mechanical and environmental stresses over time. While couplers, adapters, and connectors can be employed to secure an interconnection of a cable, such structures can be difficult to accurately install and ineffective at sealing the cable from dirt, debris, and moisture. For these reasons, various embodiments are directed to a seal assembly that can operate in a cable cartridge system to provide enhanced installation speed and accuracy while optimizing environmental protection.

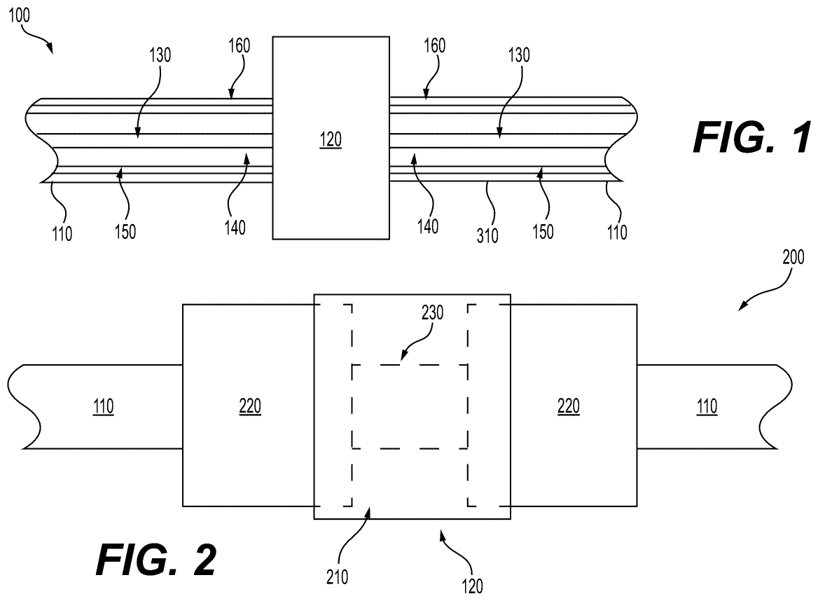

Various embodiments or a seal assembly are illustrated in the drawings. In FIG. 1, a line representation of an example cable assembly 100 is generally shown that can utilize a seal assembly. The cable assembly 100 can employ one or more cables 110 that continuously extend for any distance between a signal source and a signal destination. One or more interconnections 120 can operate to connect the cable 110 to another cable 110, an interface, an adapter, a fitting, or a site terminal. It is noted that a cable 110 can employ an interconnect 120 to connect a protective sleeve, or tube, with a cable 110 that continuously extends through the interconnect 120.

Although not required or limiting, the cable 110 can have a fiber optic conduit 130 that is surrounded by an insulating material 140. One or more shielding layers 150 can be positioned between the insulating material 140 and an outer jacket 160. The number of constituent layers and materials can contribute to the overall diameter and operational performance characteristics of the cable 110. The interconnect 120 may be configured to accommodate any diameter cable 110 with any number, type, and size of constituent materials.

FIG. 2 illustrates a line representation of portions of an example cable assembly 200 in which a seal assembly can be employed in accordance with various embodiments. The cable assembly 200 conveys how an interconnect 120 can include a coupler portion 210 that physically secures a pair of seals 220 that respectively surround portions of one or more cables 110 to provide protection from environmental elements, such as dirt, debris, and moisture. It is contemplated that the interconnect 120 combines different cables 110 or cables 110 with matching physical and performance characteristics.

As shown, the respective seals 220 can be partially housed within an interior cavity defined by the coupler 210. Such seal 220 configuration that continuously extends from within the coupler 210 to an axial distance outside the interior cavity of the coupler 210 can combine to provide mitigation of mechanical and environmental stresses on the cable(s) 110. Some embodiments of the cable assembly 200 arrange for a connector to allow a cable 110 to continuously extend through the coupler 210 or join two separate cables 110 within the coupler 210, as shown by segmented region 230. However, despite the use of seals 220 to provide mechanical and/or environmental protection for the interconnect 120, existing seals 220 can be ineffective at isolating both mechanical and environmental aspects encountered by the cable assembly 200 during use over time.

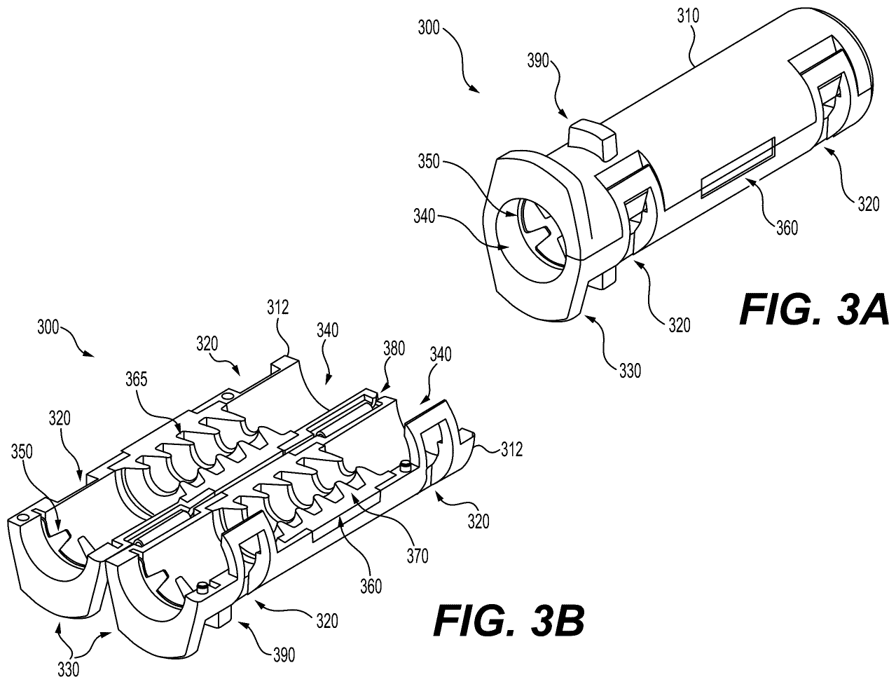

Accordingly, various embodiments may be directed to providing a cable seal assembly that increases mitigation of mechanical and environmental threats while being easy to accurately install. FIGS. 3A and 3B respectively convey perspective views of an exemplary sealing device, or cable seal 300, that can be utilized alone and/or in the cable assemblies 100/200 of FIGS. 1 and 2. The seal assembly 300 has a body, or body portion 310, that can be any size, shape, and material and configured to surround and secure a cable 110. In some aspects, the body 310 may comprise a unitary, rigid body that surrounds portions of the cable 110; that is, the body portion 310 may comprise a monolithic structure of unitary construction. It is contemplated, in some aspects, that portions of the body 310 may be flexible, but such configuration is not required.

Referring to FIG. 3B, in some aspects, the body portion 310 may include two body portions 312 that are configured to be coupled with one another. For example, the two body portions 312 may be hingedly coupled with one another via a hinge portion 380, such as, for example, a living hinge, as discussed in more detail below.

The seal assembly 300 may include a closure portion 320. In some aspects, the closure portion 320 may include a pair of closure portions 320, or features, that each allow the body 310 to close to encircle a cable, as shown in FIG. 3A, or open to receive a cable, as shown in FIG. 3B. A seal assembly 300, in various embodiments, can have any number, type, and/or position of closure portions 320. For instance, a body 310 can employ a single closure portion 320 or multiple portions 320 with matching, or dissimilar, closure types, such as snaps, latches, springs, tabs, or other engagements that secure two halves together. It is noted that the respective matching closure portions 320 shown in FIGS. 3A and 3B each have a first body portion engagement feature, for example, a latch, that may have a continuously curvilinear outer shape to be consistent with the generally circular outer shape of the body 310, and a second body portion engagement feature, for example, a catch, that is configured to receive the first body portion engagement feature to securely couple the first body portion with the second body portion in a closed position.

The body 310 may have a flange portion 330 at one end and may define a cable receiving portion 340, for example, a channel or bore, that continues throughout the longitudinal axis of the body 310. A retention member 350, for example, a washer with one or more cantilevered teeth or fingers, may be positioned proximal an entry of the channel 340 and presents several cantilevered fingers to position and/or isolate a cable entering the body 310. The retention member 350, in some embodiments, is positioned partially, or wholly, within a groove of the body 310, as shown, with the teeth or fingers projecting into the body channel 340. Various embodiments of the retention member 350 provide a one-piece construction, while other embodiments construct the retention member 350 as a two-piece unit, as shown in FIG. 3B. It is contemplated that the body 310 is configured to allow the washer to be replaced, or altered. For instance, a first retention member 350 with a first finger configuration can be swapped for a second retention portion with the same or a different, second finger configuration, which may accommodate secure retention of cables of different types and/or sizes.

Other aspects of the seal assembly 300 are contemplated as modular. The seal assembly may include a sealing portion 360 configured to be received by the body portion 310. For example, the sealing portion 360 may comprise an insert having an engagement portion 370 that is configured to respectively engage a portion of a cable to physically retain the cable while preventing external contaminants, such as dirt, debris, and moisture, from passing through the body channel 340. As illustrated, the engagement portion 370 extend radially inward from the body portion 310 into the cable receiving portion 340. In some aspects, the engagement portion 370 may include a series of sealing features that respectively engage portions of a cable to physically retain the cable while preventing external contaminants, such as dirt, debris, and moisture, from passing through the body channel 340.

The sealing portion 360 may have any number, size, and orientation of sealing features to provide optimal retention and protection of a cable. For example, the sealing portion 360 may have grooves 365 that separate differently shaped ridge-shaped portions of the engagement portion 370. As another example, the portions of the engagement portion 370 can have a tapered configuration, and some portions of the engagement portion 370 may extend into the body channel 340 further than other portions of the engagement portion 370. In some aspects, the engagement portion 370 may be configured to accept various sized cables, for example, rigid cables, ranging from 2.2 mm to 8.0 mm cables, for example. For smaller cables, a lesser number of portions of the engagement portion 370 may be configured to engage the cable than for a larger cable, where all of the portion of the engagement portion 370 may engage the cable.

The sealing portion 360 may fit into the body 310 in a variety of different manners. For instance, an interference fit may be provided to retain the sealing portion 360 in place within the body 310 and in a designated place along the channel 340. Another instance orients the sealing portion 360 in the body 310 with one or more grooves, ridges, cutouts, notches, and/or protrusions that individually and collectively retain the sealing portion 360 in place despite movement of the body 310 and/or cable 110.

In the non-limiting example of the sealing portion 360 shown in FIG. 3B, a series of engagement portions 370 are separated while having similar shapes and sizes that promote retention of a cable along a single axial direction of the retained cable. It is noted that the sealing portion 360 can be a unitary piece or a multi-piece structure that functions by surrounding and engaging a cable with one or more portions of the engagement portion 370. The body 310 can be configured, as shown, to allow the sealing portion 360 to be removed and replaced at will due to one or more retention notches that ensure an installed portion 360 is properly oriented and positioned within the body 310 and channel 340.

As mentioned above, the two body portion 312 may be a monolithic structure wherein the two body portions 312 are hingedly movable via a hinge portion 380, such as a living hinge, as would be understood by persons skilled in the art. In some aspects, the sealing assembly 300 may be arranged with unitary construction where a cable is fed through the retention member 350 and scaling portion 360 without the body 310 having a capability to open and close via closure portions 320. Still other embodiments may utilize one or more hinges 380 that allow the body 310 to reliably and accurately open and close as a multi-piece structure.

The body 310 may further present one or more installation tabs 390 that protrude from the body 310 to aid installation, removal, and alteration of the sealing assembly 300 over time. Such modularity and selective opening of the sealing assembly 300 can allow for a diverse array of cable retention and sealing compatibilities.

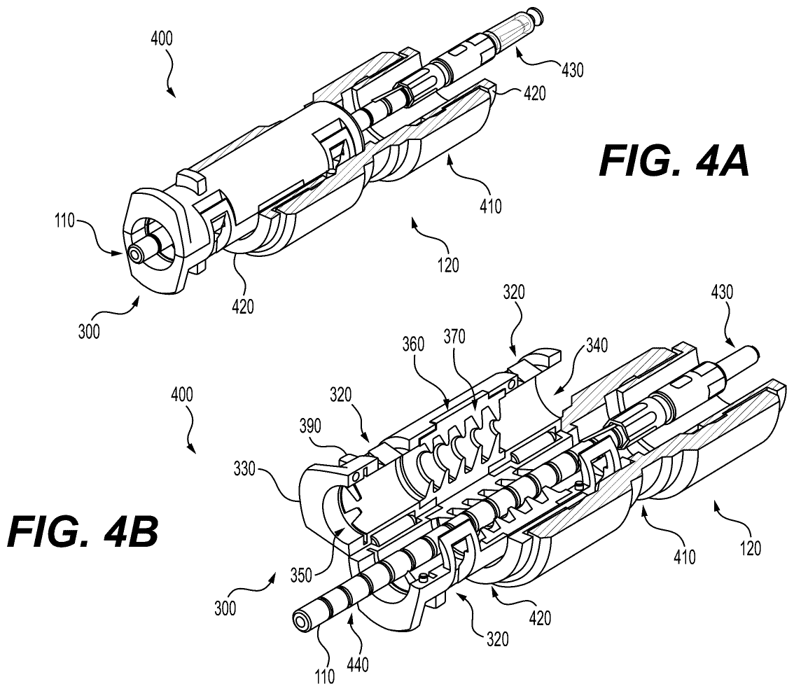

FIGS. 4A and 4B respectively illustrate perspective views of portions of an example cartridge system 400 in which the sealing assembly 300 may be employed in accordance with various embodiments. A connector 410 is shown that may be configured to secure one or more sealing assemblies 300 with positioning insert(s) 420 to protect one or more cables 110, as shown. A positioning insert 420 can be any size, shape, or material to allow a sealing assembly 300 to form a physically secure seal between the cartridge connector 410 and the sealing assembly 300. For example, in some aspects, the connector 410 may comprise a push-fit manifold or cartridge system, such as, a John Guest® manifold, for example, a JG Speedfit push-fit manifold, or any other commercially available manifold, which is well known and understood by persons of skill in the art. In some aspects, the connector 410 may comprise a generic push-fit manifold, for example, a 12.0 mm push-fit cartridge.

FIG. 4A displays how the sealing assembly 300 is partially housed within, and extends from within, the cartridge connector 410 to allow the cable 110 to extend to a terminal connection 430. The retention member 350 and scaling portion 360 of the sealing assembly 300, as shown in FIG. 4B, collectively operate to secure the cable 110 and isolate and/or protect the terminal connection 430 from inadvertent movement and contaminants.

The cable 110, in some embodiments, may have circumferential grooves 440 along its length that allow the cantilevered fingers of the retention member 350 and engagement portions 370 to engage and retain the cable 110 in substantially the center of the channel 340 and sealing portion 360 despite movement of the cable 110. That is, the configuration of the retention member 350 can physically contact a cable groove 440 or a raised portion between grooves 440 to provide a suspension that absorbs and dampens cable forces to retain the cable 110 in position relative to the sealing portion 360, the assembly channel 340, and the cartridge connector 410. Some embodiments of the sealing portions 360 present the engagement portions 370 to define a tapering channel diameter along the longitudinal length of the sealing portions 360 to secure the position and integrity of the fiber optic cable 110.

It is noted that the perspective views of FIGS. 4A and 4B each are shown with a single sealing assembly 300 positioned in the cartridge connector 410, which is illustrated in cross-section. Various embodiments utilize a second sealing assembly 300 positioned in the opposite side of the connector 410 from the assembly 300 shown in FIGS. 4A and 4B, as generally conveyed in the interconnect 120 of FIG. 2. The ability to use a single sealing assembly 300, as illustrated in FIGS. 4A and 4B, or multiple sealing assemblies 300 allow the cartridge connector 410 to be employed in a diverse variety of manners to physically and environmentally isolate a cable 110 that is configured with, or without, retention grooves 440.

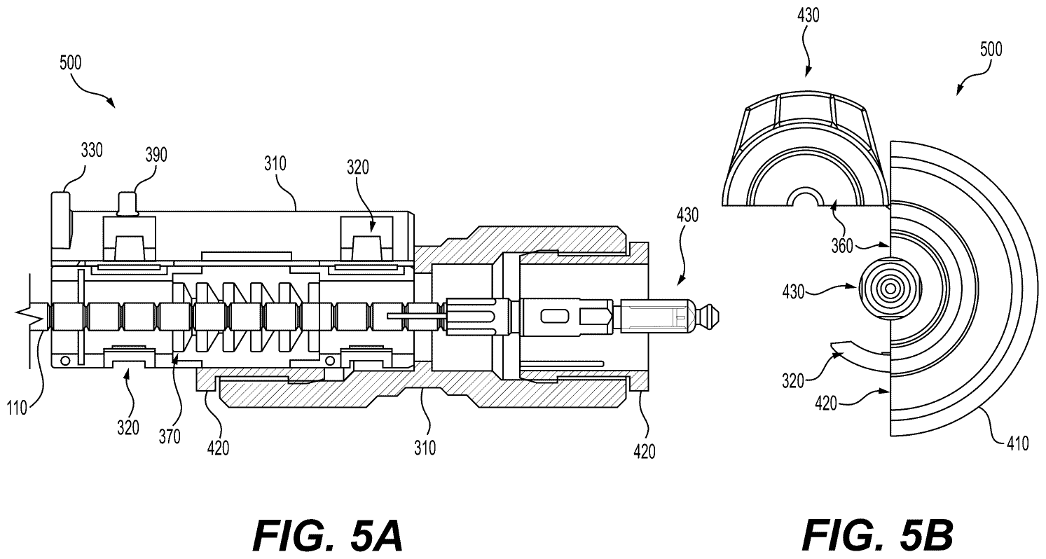

FIGS. 5A and 5B respectively illustrate cross-sectional top and front views of portions of an example cartridge system 500 that can be used in accordance with various embodiments in fiber optic cable distribution. The cross-sectional view shown in FIG. 5A conveys a scaling assembly 300 open with the respective closure portions 320 and positioned partially within the cartridge connector 410. A positioning insert 420 is positioned between the sealing assembly body 310 and the cartridge connector 410 to ensure a sealed physical interface between the sealing assembly 300 and the cartridge connector 410.

The cable 110 continuously extends through the sealing assembly 300 and cartridge connector 410 to the terminal connection 430 while concurrently contacting the retention member 350 and sealing portion 360. FIG. 5B illustrates a plan view from the front of the sealing assembly 300 with the sealing assembly 300 opened and the closure portions 320 separated to expose portions of the cable 110, sealing portion 360, and retention member 350. As shown, the engagement portions 370 of the sealing portion 360 operate to continuously contact an entire outer circumference of the cable 110, which promotes sealing and physical isolation from one side of the cartridge connector 410 to the opposite side.

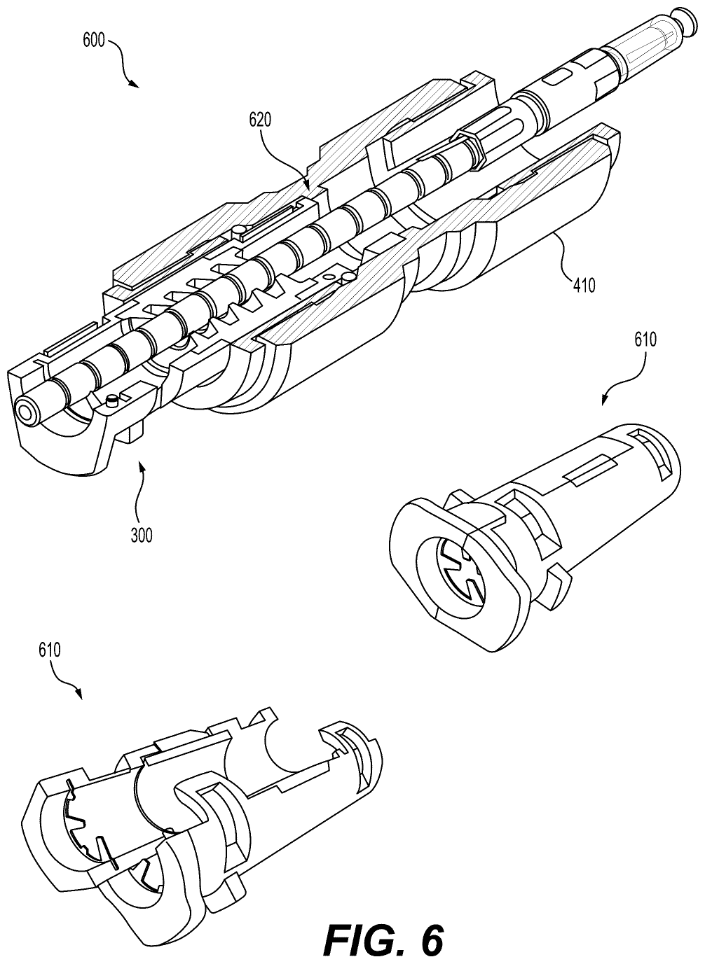

Turning to FIG. 6, perspective views of assorted portions of an example cartridge system 600 and sealing assembly 610 are respectively displayed. The cross-sectional view of the cartridge system 600 shows how a cable 110 can engage a sealing portion 360 and retention member 350 to retain the terminal connection 430 in substantially the center of the channel 340, sealing assembly 300, and cartridge connector 410. It is noted that the cartridge connector 410 has a stop portion 620, for example, a ridge, that prevents the sealing assembly 300 from being inserted too far into the cartridge connector 410. As a result, the sealing assembly 300 continuously extends from within the connector 410 to outside the connector 410, which promotes environmental scaling, particularly in conjunction with the positioning insert 420.

The example sealing assembly 610 is shown in an open configuration and a closed configuration, respectively. A retention member 350 is positioned within the sealing assembly body 310 and has a split construction that allows portions of the retention member 350 to remain in the halves of the assembly body 310 when opened. Some embodiments of the sealing assembly 610 construct the body 310 of a single piece of material, such as metal, ceramic, rubber, or polymer, into which a retention member 350 and sealing portion 360 are installed. It is contemplated that the retention member 350, sealing portion 360, and body 310 are similar, or dissimilar, materials customized to provide desired weight, strength, and durability.

Also, with respect to the various embodiments of the present disclosure, the components of the cable 110 can be constructed of various materials which have some degree of elasticity or flexibility. The elasticity enables the cable 110 to flex or bend in accordance with broadband communications standards, installation methods or installation equipment. Also, the radial thicknesses of the cable 110, the signal pathway conductor 130, insulator 140, any shielding layers 150, and the outer jacket 160 can vary based upon parameters corresponding to broadband communication standards or installation equipment.

Additional embodiments include any one of the embodiments described above, where one or more of its components, functionalities or structures is interchanged with, replaced by or augmented by one or more of the components, functionalities or structures of a different embodiment described above. It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

What is claimed is:

1. A cable holder configured to sealingly hold different sized cables, comprising
a body portion;
a cable receiving portion structurally configured to extend through the body portion along a longitudinal axis of the body portion;
a sealing portion structurally configured to be coupled with the body portion;
a retaining portion structurally configured to be coupled with the body portion;
wherein the retaining portion is structurally configured to engage a cable that extends through the cable receiving portion so as to prevent relative movement between the cable and the body portion along the longitudinal axis;
wherein the body portion includes a first body portion hingedly coupled with a second body portion;
wherein the body portion comprises a single piece of unitary construction such that the first body portion and the second body portion are hingedly coupled via a living hinge;
wherein the sealing portion includes a first sealing portion configured to be received by the first body portion and a second sealing portion configured to be received by the second body portion;
wherein the sealing portion includes an engagement portion structurally configured to extend radially inward from the body portion into the cable receiving portion so as to narrow a cross-sectional passage through the cable receiving portion;
wherein the engagement portion includes a first engagement portion and a second engagement portion spaced apart from one another along the longitudinal axis;
wherein the first engagement portion extends further into the cable receiving portion than the second engagement portion such that the first engagement portion defines a first opening through the cable receiving portion that is smaller than a second opening defined by the second engagement portion;
wherein the first engagement portion and the second engagement portion are configured to be biased radially outward toward the body portion; and
wherein the first engagement portion is structurally configured to sealingly engage a cable having a first outside diameter that is greater than or equal to a diameter of the first opening and less than a diameter of the second opening, and the first engagement portion and the second engagement portion are structurally configured to sealingly engage a cable having a second outside diameter that is greater than or equal to the diameter of the second opening such that the cable holder is structurally configured to sealingly hold cables having different sized diameters.

2. The cable holder of claim 1, wherein the retention portion includes a gripping portion configured to grip a cable passing there through.

3. The cable holder of claim 2, wherein the gripping portion is structurally configured to grip an annular groove in a jacket of a cable passing there through.

4. The cable holder of claim 2, wherein the retention portion comprises a washer, and the gripping portion comprises radially inward directed teeth.

5. The cable holder of claim 1, wherein the sealing portion comprises a flexible sealing portion.

6. The cable holder of claim 5, wherein sealing portion comprises silicon or a thermoplastic elastomer.

7. A cable seal assembly comprising:
the cable holder of claim 1; and
a push-fit cartridge configured to receive the cable holder in a push-fit relationship.

8. A cable holder configured to sealingly hold different sized cables, comprising a body portion;
a cable receiving portion structurally configured to extend through the body portion along a longitudinal axis of the body portion;
a sealing portion structurally configured to be coupled with the body portion;
wherein the body portion includes a first body portion hingedly coupled with a second body portion;
wherein the sealing portion includes an engagement portion structurally configured to extend radially inward from the body portion into the cable receiving portion so as to narrow a cross-sectional passage through the cable receiving portion;
wherein a first portion of the engagement portion extends further into the cable receiving portion than a second portion of the engagement portion such that the first portion defines a first opening through the cable receiving portion that is smaller than a second opening defined by the second portion; and
wherein the first portion is structurally configured to sealingly engage a cable having a first outside diameter that is greater than or equal to a diameter of the first opening and less than a diameter of the second opening, and the first portion and the second portion are structurally configured to sealingly engage a cable having a second outside diameter that is greater than or equal to the diameter of the second opening such that the cable holder is structurally configured to sealingly hold cables having different sized diameters.

9. The cable holder of claim 8, further comprising a retaining portion structurally configured to be coupled with the body portion; and
wherein the retaining portion is structurally configured to engage a cable that extends through the cable receiving portion so as to prevent relative movement between the cable and the body portion along the longitudinal axis.

10. The cable holder of claim 9, wherein the retaining portion includes a gripping portion configured to grip a cable passing there through.

11. The cable holder of claim 10, wherein the retaining portion comprises a washer, and the gripping portion comprises radially inward directed teeth.

12. The cable holder of claim 10, wherein the gripping portion is structurally configured to grip an annular groove in a jacket of a cable passing there through.

13. The cable holder of claim 8, wherein the body portion comprises a single piece of unitary construction such that the first body portion and the second body portion are hingedly coupled via a living hinge.

14. The cable holder of claim 8, wherein the sealing portion includes a first sealing portion configured to be received by the first body portion and a second sealing portion configured to be received by the second body portion.

15. The cable holder of claim 8, wherein the first portion and the second portion of the engagement portion are configured to be biased radially outward toward the body portion.

16. The cable holder of claim 8, wherein the first portion and the second portion of the engagement portion are spaced apart from one another along the longitudinal axis.

17. The cable holder of claim 8, wherein the sealing portion comprises a flexible sealing portion.

18. The cable holder of claim 17, wherein the sealing portion comprises silicon or a thermoplastic elastomer.

19. A cable holder configured to sealingly hold different sized cables, comprising a body portion;
a cable receiving portion structurally configured to extend through the body portion along a longitudinal axis of the body portion;
a sealing portion structurally configured to be coupled with the body portion;
wherein the sealing portion includes an engagement portion structurally configured to extend radially inward from the body portion into the cable receiving portion so as to narrow a cross-sectional passage through the cable receiving portion; and
wherein a first portion of the engagement portion is structurally configured to sealingly engage a cable having a first outside diameter that is greater than or equal to a first diameter and less than a second diameter, and the first portion and the second portion are structurally configured to sealingly engage a cable having a second outside diameter that is greater than or equal to the second diameter such that the cable holder is structurally configured to sealingly hold cables having different sized diameters.

20. The cable holder of claim 19, wherein the first portion of the engagement portion extends further into the cable receiving portion than a second portion of the engagement portion such that the first portion defines a first opening through the cable receiving portion having the first diameter that is smaller than a second opening defined by the second portion having the second diameter.

21. The cable holder of claim 19, further comprising a retaining portion structurally configured to be coupled with the body portion; and
wherein the retaining portion is structurally configured to engage a cable that extends through the cable receiving portion so as to prevent relative movement between the cable and the body portion along the longitudinal axis.

22. The cable holder of claim 21, wherein the retaining portion includes a gripping portion configured to grip a cable passing there through.

23. The cable holder of claim 22, wherein the retaining portion comprises a washer, and the gripping portion comprises radially inward directed teeth.

24. The cable holder of claim 22, wherein the gripping portion is structurally configured to grip an annular groove in a jacket of a cable passing there through.

25. The cable holder of claim 19, wherein the body portion includes a first body portion hingedly coupled with a second body portion;

26. The cable holder of claim 25, wherein the body portion comprises a single piece of unitary construction such that the first body portion and the second body portion are hingedly coupled via a living hinge.

27. The cable holder of claim 25, wherein the sealing portion includes a first sealing portion configured to be received by the first body portion and a second sealing portion configured to be received by the second body portion.

28. The cable holder of claim 19, wherein the first portion and the second portion of the engagement portion are configured to be biased radially outward toward the body portion.

29. The cable holder of claim 19, wherein the first portion and the second portion of the engagement portion are spaced apart from one another along the longitudinal axis.

30. The cable holder of claim 19, wherein the sealing portion comprises a flexible sealing portion.

31. The cable holder of claim 19, wherein the sealing portion comprises silicon or a thermoplastic elastomer.
